(19) United States
(12) Patent Application Publication
(10) Pub. No.: US 2010/0093396 A1
(43) Pub. Date: Apr. 15, 2010

(54) SYSTEMS AND METHODS FOR STORING OR PERFORMING FUNCTIONS WITHIN REMOVABLE MEMORY, SUCH AS A SUBSCRIBER IDENTITY MODULE OF A MOBILE DEVICE

(76) Inventor: Brian Roundtree, Kirkland, WA (US)

Correspondence Address: PERKINS COIE LLP;PATENT-SEA, P.O. BOX 1247, SEATTLE, WA, 98111-1247, US

(21) Appl. No.: 12/444,332

(22) PCT Filed: Oct. 3, 2007
(86) PCT No.: PCT/US07/80351

§ 371 Date: Dec. 28, 2009

Related U.S. Application Data
(60) Provisional application No. 60/849,390, filed on Oct. 3, 2006.
(60) Provisional application No. 60/857,993, filed on Nov. 8, 2006.

(51) Int. Cl. H04M 1/02; H04M 1/00

(52) U.S. Cl. 455/558; 455/557

(57) ABSTRACT

A system and method of storing applications and other processes on a subscriber identity module of a mobile device is described. In some examples, the system employs the SIM to store and execute scripts that perform call interception. In some examples, the system employs SIM-based scripts to configure and/or diagnose issues with the mobile device. In some examples, the system extends the operating system of the mobile device via an operating system contained within the SIM device.

### CROSS-REFERENCE TO RELATED APPLICATION(S)

This application claims the benefit of U.S. Provisional Patent Application No. 60/849,390, filed on Oct. 3, 2007, entitled MOBILE DEVICE METHODS, SUCH AS REMOTE LOGISTICS MANAGEMENT AND CONFIGURATION APPLICATIONS STORED LOCALLY ON A MOBILE DEVICE, and U.S. Provisional Patent Application No. 60/857,993, filed on Nov. 8, 2006, entitled SIM BASED METHODS, SUCH AS EXTENDED OR EMBEDDED OPERATING SYSTEMS FOR MOBILE DEVICES, both of which are incorporated by reference in their entirety.

### BACKGROUND

The increased use of mobile devices encourages competition between phone manufacturers, service providers, and other entities associated with mobile technology. In order to get ahead of the competition, manufacturers may provide their mobile devices with additional applications, functions, and other tools stored within the memory of the mobile devices. However, adding more memory leads to increased costs in manufacturing the devices.

Sometimes, competitors of service providers attempt to attract customers using dubious or underhanded methods. Competitors may hack or attempt to control aspects of a mobile device, in order to redirect a customer's interest to their company and products. Therefore, problems arise in securing a customer's mobile device processes from others.

Also, increased competition leads to new improvements and services provided with mobile devices. In order to take advantage of new services, customers often purchase new devices to replace fully functioning equipment. Additionally, because customers do not always want to purchase new devices soon after a previous purchase, manufacturing processes may be delayed until devices contain enough new functions to entice consumers to upgrade their devices. Therefore, problems exist regarding the ability and ease of providing customers with the latest new and improved functions and services.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a block diagram illustrating components of a mobile device

FIG. 2 is a block diagram illustrating an example architecture for a SIM-based system.

FIG. 3 is a block diagram illustrating data processes between a mobile device operating system and a SIM device.

FIG. 4 is a map diagram illustrating various examples of processing architectures.

FIG. 5 is a block diagram illustrating components used in the SIM-based system.

FIG. 6 is a flow diagram illustrating a routine for implementing SIM based logistics management and configuration.

FIG. 7A is a flow diagram illustrating a routine for detecting mobile device attributes, configurations, or settings.

FIG. 7B is a flow diagram illustrating a routine for installing scripts and resources.

FIG. 8 is a flow diagram illustrating a routine for intercepting and redirecting a customer service support call from the mobile device using the call control capabilities of the SIM/USIM (Universal Subscriber Identity Module).

FIG. 9 is a flow diagram illustrating a routine for installing SIM-based operating system extensions on a mobile device.

FIG. 10 is a block diagram illustrating an example of an extended embedded operation system within a SIM.

FIG. 11 is a block diagram illustrating an example of virtual memory address space.

FIG. 12 is a block diagram illustrating an example extended operating system architecture for a mobile device and SIM.

The headings provided herein are for convenience only and do not necessarily affect the scope or meaning of the claimed system.

### DETAILED DESCRIPTION

A system and method for providing services on a mobile device via a subscriber identity module (SIM) or other replaceable or removable module carrying a processor with associated memory is described. In some cases, the mobile device contains a few components used to operate the phone, with most processes being performed using components within the SIM card. For example, a manufacturer may create a simplified, standards-based mobile device that does not require a large memory and is inexpensive to manufacture. Such a device may rely on processes within a SIM card to provide applications and functions to a user of the device.

In some cases, the system locally intercepts calls from a mobile device and provides enhanced services such as customer self-support using scripts executed within the SIM. For example, a user may dial a predetermined number (such as a number related to an enhanced service), and software stored on the SIM may intercept the call when the number is dialed, after the call has gone through, while the call is on hold, and so on. For example, when the SIM-based process matches a dialed number to a customer support service number, the process may cause the mobile device to interrupt the attempted call and display a list of potential solutions (also stored on the SIM) to the subscriber's problems to the user via the mobile device.

In some cases, the system provides logistics monitoring and support, alerts users to services and other applications, plays video and other multimedia files, and so on, all via scripts executing primarily within the SIM card. In some cases, using the processor and associated memory within the SIM card enables the system to provide a more secure environment when performing these and other processes described herein.

The system will now be described with respect to various embodiments. The following description provides specific details for a thorough understanding of, and enabling description for, these embodiments of the system. However, one skilled in the art will understand that the system may be practiced without these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable System

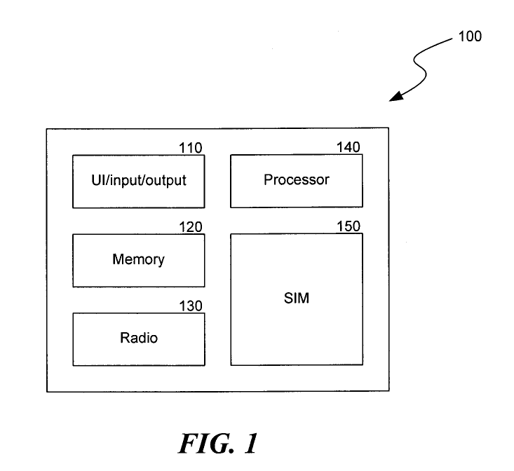

FIG. 1 illustrates a block diagram of a mobile device 100 on which SIM-based processes and/or applications can be supported. The mobile device 100 includes a user interface and other inputs and outputs (e.g., keypad, touch-based navigation components, microphone, speaker, visual display, and so on) 110, a memory 120, such as programmable non-volatile memory, and a radio component 130, such as a receiver/demodulator that receives a transmitted signal via an antenna and reconstructs the original transmitted signal and a transmitter/modulator that generates and transmits a signal. Furthermore, the mobile device 100 includes a processor 140, which may receive and send transmitted signals from the radio 130, may receive signals from the user interface and various inputs 110, may transmit signals to the user interface 110, and so on. In some cases, the mobile device may include a microcontroller (not shown) containing a decoder, a processor, RAM (Random Access Memory), digital signal processor, and so on. In addition, the mobile device may include optional components, such as an automated data collection unit linked to the processor, which can include an automated RFID (Radio Frequency Identification) tag reader, a magnetic card swipe reader, a bar code reader, and others. Additionally, or alternatively, the mobile device may include a biometric reader (e.g., thumbprint reader, voice fingerprint recognition functionality, etc.), and/or a media output device (e.g., MP3 player, television tuner/player, etc.). Other hardware components can of course be included.

The mobile device also includes a subscriber identity module (SIM) 150, such as a SIM having a memory component and capable of storing scripts, applications, and other processes that assist the mobile device in providing functions and services to users. The system may run and store scripts and other application within the SIM card 150, a Universal Integrated Circuit Card (UICC), or any removable secure microprocessor having associated memory. These and similar devices are interchangeable with respect to aspects of the technology, and the term “SIM” is simply used for convenience herein. In general, the system may store any and all components, modules, or data files required or used in providing services to users of the mobile devices.

The SIM 150 (or other removable memory cards) and device may act as a “computer on a chip.” They may contain a processor for executing scripts and files, a memory for storing scripts and files, and an operating system. Also called High Capacity SIMs, MegaSIMs, High Density (HD) SIMs, and SuperSIMs, they may have storage capabilities of 4 MB to 1 GB, and may enable 16 bit or 32 bit processors. The system described herein may be implemented in some or all of the SIMs listed above.

FIG. 1 and the discussion herein provide a brief, general description of a suitable telecommunications or computing environment in which the system can be implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

The mobile device 100 and/or SIM 150 may provide services that include executable software, software configurations, hardware configurations and controls, and handset operating system interfaces. As disclosed herein, executable software may include, without limitation, any software program stored on the mobile device or associated memory device, both permanently and temporarily connected via hardware or wireless connectivity. For example, the SIM 150 may include an authentication system, a mobile device interface, a report system, a script interface, a script platform, data, and scripts.

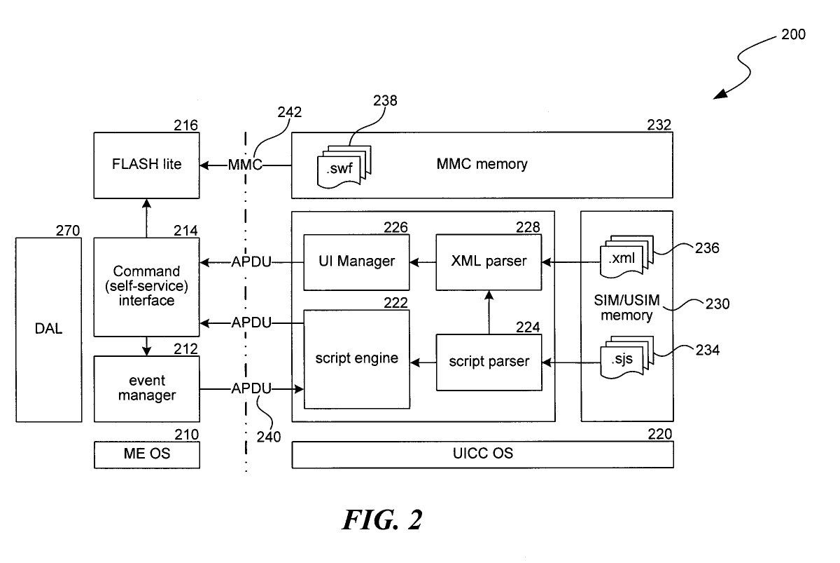

Referring to FIG. 2, a block diagram illustrating an example architecture for a SIM-based system 200, where many components are stored and executed outside of a mobile device operating system 210, is shown. The mobile device's operating system (OS) 210 includes components such as an event manager 212 and a command interface 214 (such as a self-service interface). The system stores a script engine 222 for executing scripts, a script parser 224 for reviewing and determining what scripts to execute, a UI manager 226 for managing the user interface processes within the SIM, and an XML parser 228 within, and for execution by, an operating system 220 of a UICC, such as a SIM, integrated into or carried by a mobile device 200. The SIM OS 220 may contain some or all of these components (in some cases, these components may be components used by the system in performing the call intercept methods described herein). The SIM OS 220 may also contain a SIM/USIM memory 230 and a MMC memory 232. The system may use the memory 230 to store application files, data files, resources, and so on, such as .sjs (javascript specific) files 234 and .xml files 236. The system may use memory 232 to store multimedia application files, such as the .swf files 238 shown within the memory 232.

The event manager 212 calls preconfigured functions, such as “callback” functions when appropriate event triggers are encountered. Some examples of event triggers include, but are not limited to, a mobile device entering or returning from a power savings mode, a device data or power cable being connected or disconnected, the user pressing a specific button, specific buttons or a button sequence, the display being modified, the user initiating or receiving a phone call on the device, the device receiving or sending a message such as an SMS (Short Messaging Service), MMS (Multimedia Messaging Service), or IM (Instant Messaging) message, a portion of ME memory/storage 210 being modified, such as a database entry being created, changed, or removed (such as a new contact being added), a file matching a predetermined name and/or directory location being created, modified, or deleted, a network malfunction being encountered, and so on.

The self-service interface 214 enables a script engine 222 and/or a UI manager 226 located within a SIM OS 220 to issue run-time commands across a ME-SIM interface 240 to ME OS 210 components, such as the display engine 216 and the event manager 212. For example, the script engine 222 may call the self-service interface 214 to register a new callback function provided by a resource script file 234, in order for the callback function to be triggered when a specific event occurs, such as when the user requests a call be made to the cellular service provider's customer support center.

Additionally, the ME OS 210 or a combination of both the ME OS 210 and the SIM OS 220 may contain a client specific device abstraction layer 270 (DAL) that enables scripts to be installed to the device independent on the type of device or type of operating system employed by the device. The DAL functions by allowing applications to access data stored in persistent storage, such as data stored in the SIM 150. For example, the DAL may include a class of data access methods for the ME OS 210 which directly reference a set of procedures used to store data within the SIM 150. Thus, via the DAL, the ME OS 210 is able to access data from the SIM using simple techniques, such as via APIs.

For example, in order to facilitate calls between the self-service interface 214 and the UI manager 226 over the ME-SIM interface 240, the DAL may be located in both the self-service interface 214 and the UI manager 226. The DAL contains all operating system specific code in one place for such calls, which allows porting of a client to the device operating system to be simpler and faster (The alternative would be operating system code strewn throughout many files). The DAL includes an API. The system may implement the DAL API onto the operating system in order to run a client (such as the self-service interface 214) on the operating system, but does not need to perform any other changes to OS code. (A client may also need to be compiled into the machine language of the device, but there is no need for operating system specific calls, and thus does not require any code changes).

Thus, in some examples of the system the DAL enables many functions typically performed between components within a device OS to be performed between the device OS and a SIM OS. For example, the DAL API enables functions grouped into the following categories (of course, others not listed below are possible):
CDAL_APHandler, which provides APN functionality
CDAL_Call, which provides call management functionality
CDAL_ConnectionManager, which provides data connection functionality
CDAL_FileWatcher, which provides file monitoring functionality
CDAL_MessagingInterface, which provides messaging functionality
CDAL_MessagingMonitor, which provides message monitoring functionality
CDAL_NetworkConnection, which provides network (HTTP) functionality
CDAL_NetworkListener, which provides network monitoring functionality
CDAL_SmsIntercepts, which provides SMS interception functionality
CDAL_Socket, which provides socket functionality.

Components stored within the mobile device OS 210, such as the event manager 212, the self-service interface 214, and/or a display engine 216 (e.g., a FLASH lite engine, a hyper text browser, a music or video player, or other multimedia application) interact with the SIM OS 220 components to perform the processes and applications described herein. Examples of these processes and applications include call-intercept methods, diagnostic methods, configuration methods, presentation methods, display methods, and so on. They may interact or communicate via smart card or processor card channels such as APDU (Application Protocol Data Units) 240 (but may alternately use other external processor card communications channels such as SIM Toolkit APIs or alternative JavaCard APIs), or memory card channels such as multimedia card (MMC) channel 242, (but may alternately use other channels such as those suitable for USB, CompactFlash, SmartMedia, MemoryStick, SecureDigital, and so on) for multimedia presentations sent from the SIM to the mobile device. The interaction between the mobile device and files and applications stored in a UICC, such as in the SIM card, will now be discussed.

### Interactions Between a Mobile Device and a SIM

In some example, the system enables storage of scripts, processes and component within the memory of a SIM providing the mobile device OS the ability to send and receive many different commands to and from the SIM OS. The following table illustrates examples of commands used by the system:

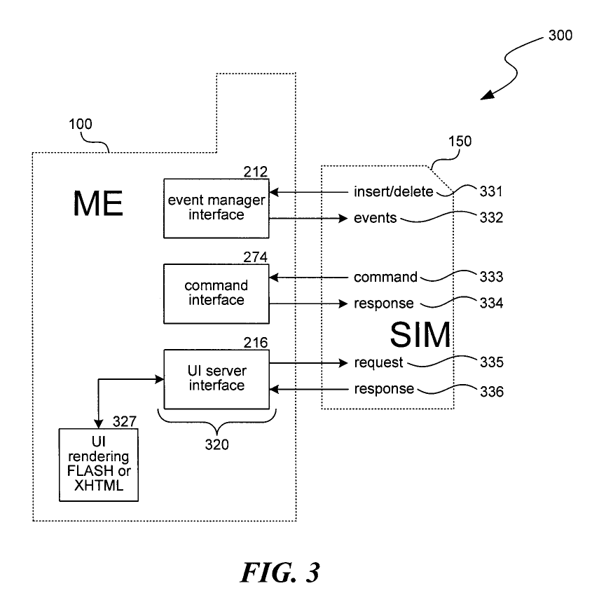

Referring to FIG. 3, a block diagram 300 illustrating an example of data commands between a mobile device operating system and a removable memory device (such as a SIM) is shown. As shown in FIG. 2, the mobile device OS 210 of the mobile device 100 may contain interface components 320, such as an event manager interface 212, a command interface 214, and/or a UI interface 216 (which may communicate with a UI rendering engine 327, such as a FLASH or XHTML component), and so on. Some or all of the interface components 320 send and/or receive data from a removable storage and processing component, such as SIM card 150.

Scripts executing on the SIM card may insert and/or delete 331 callback functions, or other data structures to and/or from the mobile device OS 210. Additionally, upon an occurrence of an event at the mobile device (e.g., an indication of a key press or other event triggers discussed herein), the event manager interface 212 calls, exposes or publishes APIs (such as callback functions) 332 to the SIM 150 to alert the SIM of the event (such as data that indicates a key scancode that was pressed). In response, the SIM may expose APIs that act to instruct 333 the command interface 214 to execute a command and/or provide additional information. In turn, the command interface 214 may respond 334 to the commands 333. Additionally, the UI server interface 216 may send requests 335 for files, pages, or other content, to be presented for consumption by the UI rendering engine 327. The SIM may, upon approval, respond 336 to requests by transmitting files stored in the SIM 150 to the UI interfaces 326 and/or rendering component 327 for display to a user via the rendering component 327. Examples of other types of requests made from the UI interface 216 to the SIM 150 may be an indication that the user filled out and submitted a user interface form, clicked on a hyperlink, selected a menu item, and so on.

As described herein, the system facilitates communications between the mobile device OS 310 and the SIM 150 via Application Programming Interfaces (APIs). For example, APIs in the OS related to an input event received by the mobile device (such as a key press) are exposed to the SIM 150 by the event manager interface 212 over the APDU channels (see event 332). Upon viewing the exposed API, a script engine on the SIM 150 may execute a script, and expose an API (such as a callback function) back to the mobile device OS 210 (see command 333). This may cause the UI server interface 216 to send a request via an API back to the SIM 150, such as an API that requests a specific page or display (see request 335). The SIM 150 may then respond by sending a static display over the APDU channel or a dynamic display over the MMC channel to the UI server interface 326 (see response 336) for presentation to a user via a user interface component, such as a display on the mobile device.

The storing of applications, engines, files, and so on within a SIM or UICC environment enables the system, in some cases, to optimize and/or simplify the memory and functionality of a mobile device and its required processes. Such architectures may minimize the porting required for full functionality of the device or may optimize mobile device code reuse by utilizing rendering systems already contained within the mobile device. Further, the system facilitates a more secure operating architecture, because the mobile device only performs consuming events authorized by a user or service provider due to the consumption occurring within the UICC. Security systems located in the SIM provide secure storage and/or pre-execution authentication. Because content related processes and scripts are contained in a secure SIM environment, the system may prevent hackers from taking over or controlling certain functions of a mobile device.

### Examples of SIM-Based Processing

Consider the following example: a new mobile device is installed with a SIM having the architecture described herein. The mobile device may contain rendering systems, event managers, and user interface components. However, many of the scripts, XML pages, flash movies and other multimedia content, branding information, customer care numbers, information numbers, enhanced or data enhanced numbers, and so on, are stored in the SIM. Thus, the mobile device executes or performs functions, retrieves scripts, files, and other data, and/or downloads applications and data over a network connection, and so on, using a secure environment controlled by the SIM.

The system may store a number of different applications within a SIM or UICC, and may use the different applications stored within the SIM when performing a number of different functions on the mobile device. Some examples include homescreen applications, music players, video players, document editors or viewers, games, blogs, videos, music tracks or ringtones, OS updates, application updates, digital rights management applications, other security applications, and so on.

Consider the following example: a user of the mobile device wishes to view a movie stored on a SIM. In some cases, flash movies may be stored within the SIM and are presented to a user via a flash player (such as Flash Lite) or other component on the mobile device OS. In this example, the ME OS receives an indication of an event, and exposes an API to the SIM card about the event (see 332 of FIG. 3). For example, the ME OS 210 receives a key press from the user that relates to the user pressing play for the media player. The SIM 150 retrieves the movie and sends a command, via an API (see 333), that causes the ME OS to begin playing the movie. The ME OS then sends a request (via an API) for the data file for the movie (335), and the SIM responds (see 336) by publishing an API to be accessed by the player when presenting the movie via the Flash player. In some cases, the player may also be stored in the SIM and the system only uses the mobile device OS to display the content to a user via the OS user interface.

Additionally, there may be base movies that launch some of the applications and functionalities described herein. In some cases, the system may store home screen and other branded OS features in the SIM and provision these features to the device upon insertion of the SIM into the device. For example, a SIM sold by Vector Mobile may, upon installation into a mobile device, install the homescreen, wallpaper, icons, theme, default ringtones, and other user environment functionality onto the mobile device. Thus, the mobile device is not required to support a service provider's branding, which may lead to lowering manufacturing costs for the manufacturer of the mobile device.

In some cases, the system may store an application manager or other scripted applications that may automatically determine what applications to start or stop based on time, location, or other parameters detected in the handset or in the SIM. In some cases, the system may store a software installer/configuration manager on the SIM which, upon insertion of the SIM into the device (or at a different time), may install onto the device, and in turn install a service provider's supported default applications or application updates onto the device.

In some cases applications stored on the SIM may pitch a promotional service to the user after inserting the SIM into the device. The system may incorporate certain scripts that execute after SIM installation and determine whether a new service should be offered to the user. For example, if a user account does not have a data plan but the provisioned device supports web browsing, then the newly installed SIM may detect the supported functionality and transmit data to the mobile device that causes the mobile device to present a promotion to the user to upgrade their mobile service plan with a data plan.

Additionally, or alternatively, the system may provide mobile device logistics management, configuration, and detection using applications, scripts, and content stored within a SIM. Using SIM based scripts, the system enables service providers to remotely update software on a customer's mobile device. In these cases, the system allows service providers to ship or make available new mobile devices to the public, because they can test and customize software on the device after a user has purchased the device. Also, the system enables service providers to provide customer-specific software. Service providers may add, delete, or update software packages installed on purchased mobile devices, providing customers with a mobile device environment geared to their specific wants and needs.

The network-based services described herein may automatically query, set, save, and restore settings on the mobile device and SIM card, or perform other functions. Alternatively, or additionally, the mobile device may locally perform diagnostic scripts on the device to gather user, device, and network data. Such scripts may be loaded over the air (OTA), and may be so loaded at any point, or initiated from a call center agent desktop computer. By either agent or mobile device initiation, diagnostic scripts on the phone are automatically initiated proactively to resolve problems encountered by the subscriber. In one embodiment, the mobile device or the call center agent can collect, via scripts, all the required information over the air without asking the subscriber.

In some cases, the system may use SIM based scripts and applications in support of the following device functionalities: anti-box breaking, memory locking, security and password storage, enterprise security, UI suppression, UI control to remote control, interactive training for new service, loss of OEM control, automatic white.grey.black listing, small atomic scripts, client server management, OEM “MMI” abstraction, supply scripts, network performance monitoring, network compliant data monitoring, call driver, call intercept specific functions (call monitors), tutorials or guides, metrics, customer care and other care applications, diagnostics, resource updating, application integration, data backup and restore, connection management, toolkit applications, web based devices and servers, and so on.

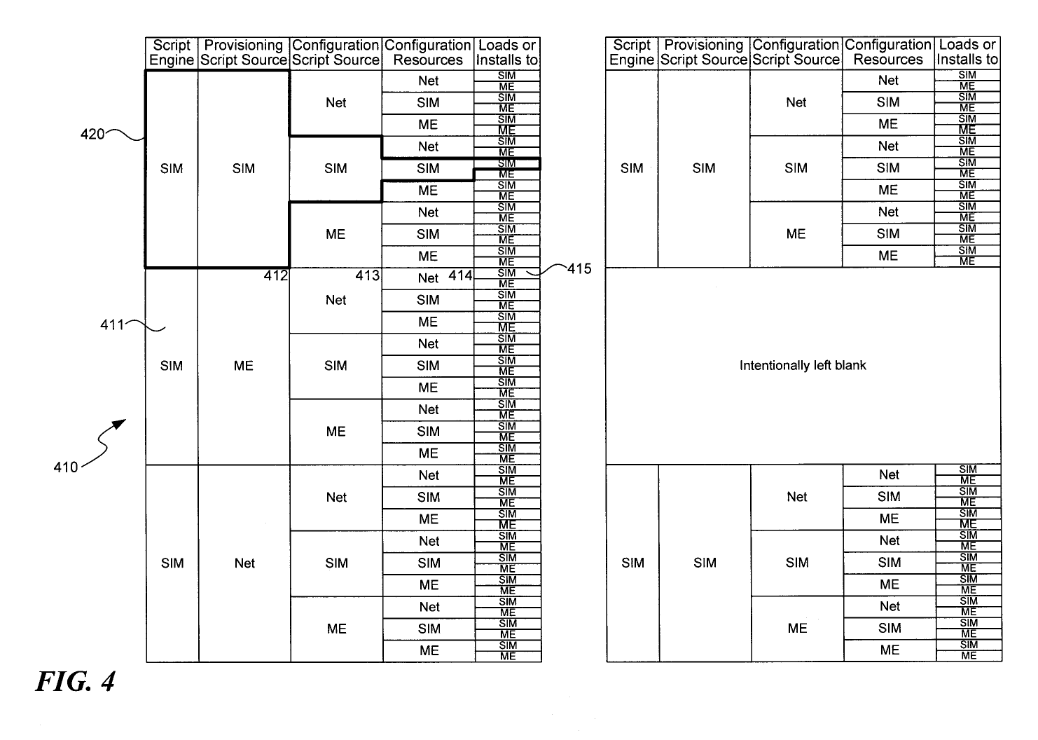

The sources of script engines, provisioning scripts, configuration scripts, and/or configuration resources may be a network server, a local device memory, or a SIM card. FIG. 4 illustrates various permutations. For example, permutation 410 reflects a script engine 411 stored within a SIM, a provisioning script source 412 stored within the mobile device, a configuration script 413 on a network, configuration resources 414 on the network, and the resources and/or script loaded 415 within the SIM. As shown in the Figure, the system considers many different permutations, such as permutation 420 which reflects all SIM contained components, and so on.

### Configuration of Mobile Devices Using SIM-Based Scripts

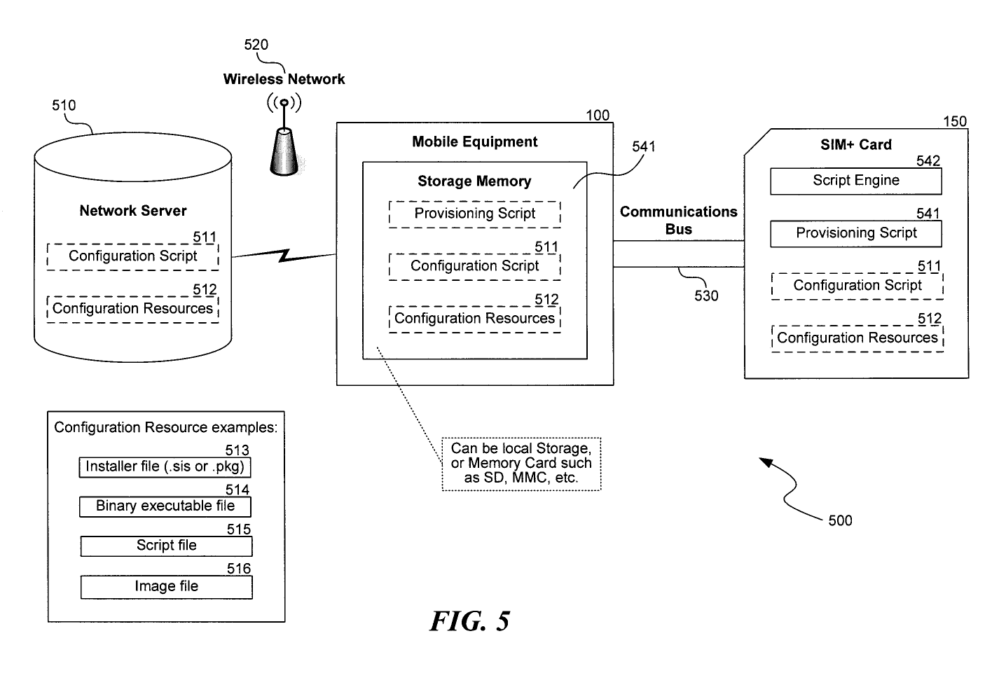

In some examples, the system configures the mobile device using SIM-based applications and scripts. Referring to FIG. 5, a block diagram 500 illustrating communications between components in a SIM-based system is shown. In this example, a network server 510 is wirelessly connected, via a network 520, to a mobile device 100 containing a SIM card 150 (such as one of the SIM cards described herein) that communicates with the mobile device 100 via a communications bus 530. The network server 510 may contain configuration scripts 511 and configuration resources 512 to be sent to the mobile device 100. Examples of configuration scripts include those discussed herein. Examples of configuration resources include installer files (e.g., sis and .pkg files) 513, binary executable files 514, script files 515, image files 516, and so on. The server may access the mobile device 100 via the SIM card 150, and transfer the scripts 511 or resources 512 to the mobile device 100. SIM card 150 may contain provisioning scripts 541, script engines 542, and other components, as needed. The device may receives and store the newly received scripts 511 and resources 512 within the SIM card, within a local memory of the device, or within other removable memory devices, such as secure digital (SD) cards, MultiMediaCards (MMC), and so on.

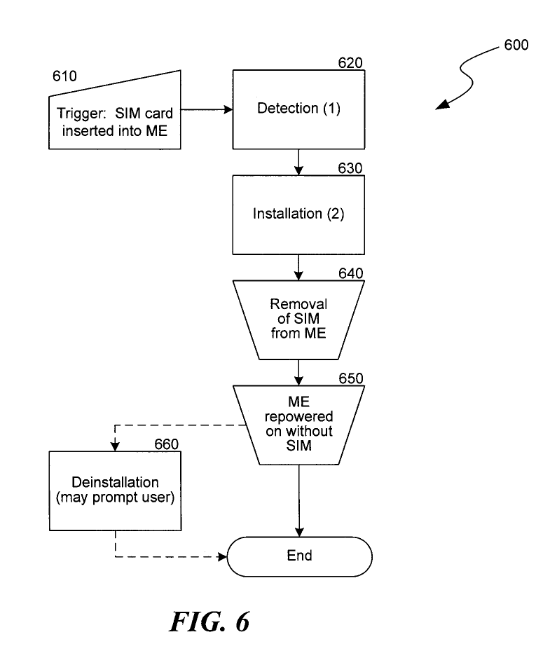

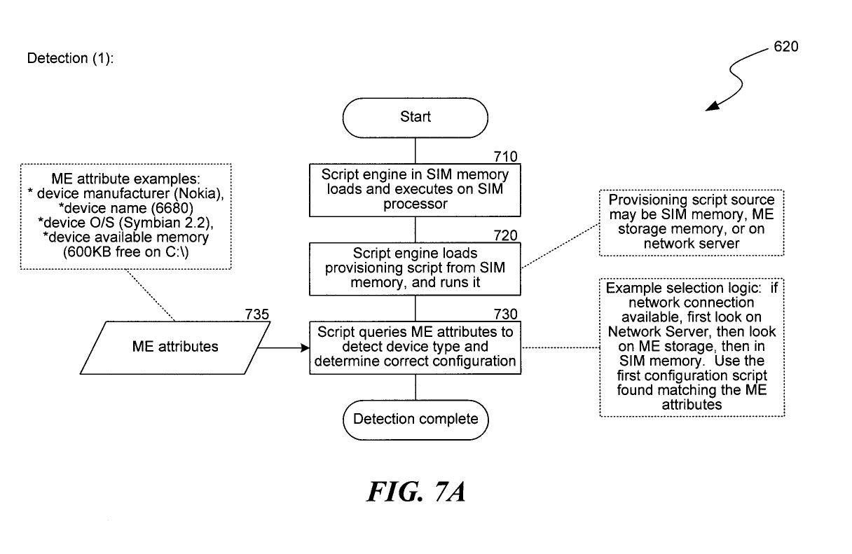

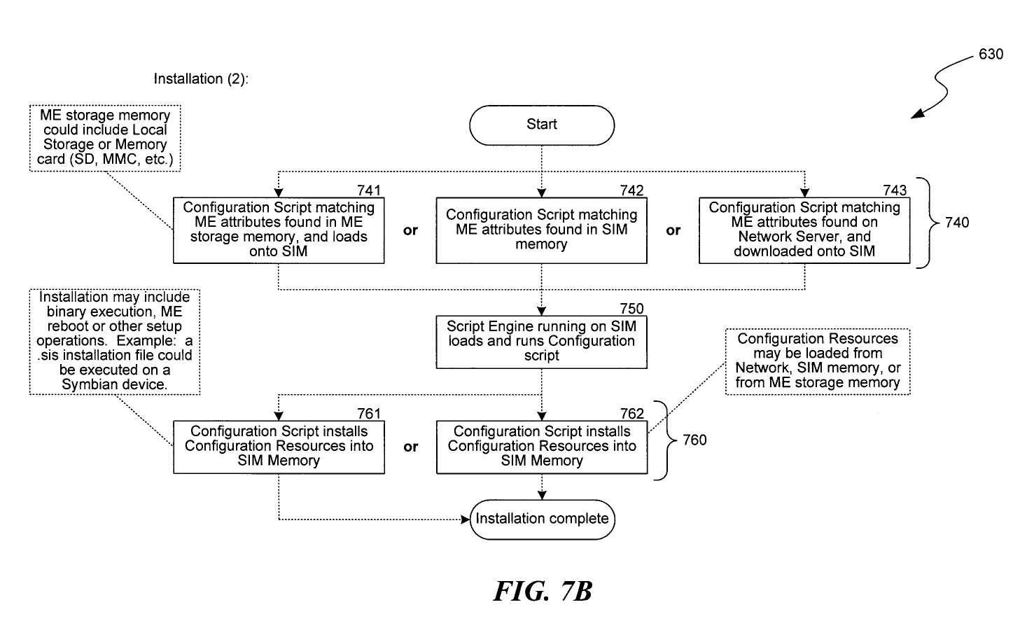

Various triggers may initiate the configuration of a mobile device, such as the configuration of the mobile device via scripts executing via a SIM card. Referring to FIG. 6, a flow diagram illustrating a routine 600 for implementing SIM based logistics management and configuration is shown. In block 610, the system receives an indication that a SIM card is inserted into a mobile device. For example, a user may insert a SIM card (having some or all of the above functionality) into a newly purchased mobile phone. In block 620, the system detects the configuration and settings of the mobile device. Further details regarding detection will be discussed with respect to FIG. 7A.

Referring to FIG. 7A, a flow diagram illustrating a routine 620 for detecting mobile device attributes, configurations, or settings is shown. In block 710, the system loads a script engine stored in the SIM memory and executes the engine via a SIM processor. In block 720, the script engine loads a provisioning script from the SIM memory. The system may retrieve the provisioning script from the SIM memory, other memory in the mobile device, or from a network server. Using the provisioning script, the system, in block 730, queries the mobile device attributes 735, detects a device type, and determines a correct configuration. In some cases, the attributes may include the device manufacturer, the device name, the device operating system, available memory, and so on. In detecting a configuration script, the system may follow a predetermined selection logic, such as looking to a network server first, followed by the device's local memory, and then to the SIM memory. Of course, the system may use other paths as appropriate. Once the configuration is determined, the routine 620 ends and routine 1600 proceeds to block 630 of FIG. 6.

Upon detection, the routine 600, in block 630, installs scripts and resources. Further details regarding installation will be discussed with respect to FIG. 7B.

Referring to FIG. 7B, a flow diagram illustrating a routine 630 for installing scripts and resources is shown. In one block of blocks 740, a detected configuration script is matched to the device configuration. Routine 630 may begin at blocks 741, 742, or 743, depending on the source of the matched script. If the system matches a script from the mobile device local memory, routine 631 proceeds to block 741, and the system loads the script onto the SIM. If the system matches a script from the SIM memory, the routine proceeds to block 742. If the system matches a script from a network server, the routine 630 proceeds to block 743, and the system downloads the script to the SIM. Once the system completes blocks 741, 742, or 743, and a configuration script is stored in the SIM memory, the routine 630 proceeds to block 750.

In block 750, the system loads and runs the configuration script on the script engine. In blocks 760, the system installs configuration resources to the device via the script. The system may install the resources to the device's memory (block 761) or to the SIM memory (block 762). Installation may be binary execution, a device reboot, or other setup type operations. For example, a .sis installation file may be executed on a Symbian device. Once the installation of resources is complete, routine 630 ends and routine 600 proceeds to block 640.

In block 640, a user removes the SIM from the device. The user may then, in block 650, power on the mobile device, now containing the installed scripts and resources. In some cases, or optionally, the system may prompt the user 660 to deinstall one or more of the installed resources not desired by the user.

### Call Interception Using SIM-Based Scripts

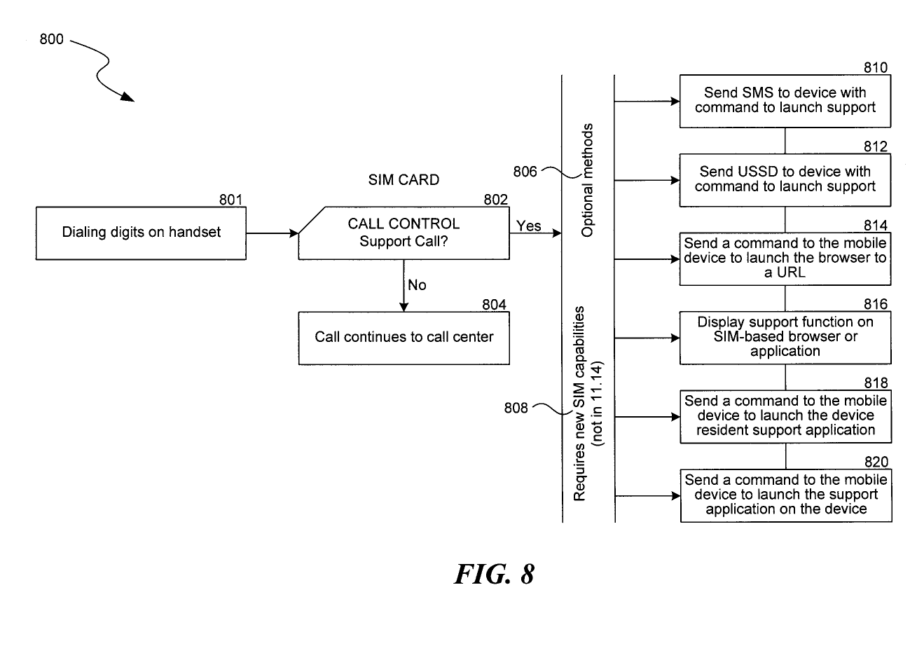

In some examples, the SIM on the mobile device may be used to intercept and to redirect customer service support calls. FIG. 8 illustrates a routine for intercepting and redirecting a customer service support call from the mobile device using the call control capabilities of the SIM via scripts stored within the SIM. In some case, the system uses built-in capabilities of a 3GPP TS 11.14 compliant (or similar) SIM or USIM to perform call control to generically reroute calls for support back to the handset via SMS, supplementary service control strings, and/or other network and handset based control commands. This allows for routing calls without altering handset dialing programs.

As shown in FIG. 8, the subscriber first dials a number on the mobile device (block 801). If the dialed number does not match a number stored on the mobile device, then the call continues to the call center without interruption (block 804). If the dialed number matches a number stored on the SIM card, then the SIM card on the mobile device intercepts and redirects the call to the SIM (block 802) using SMS, supplementary service control strings, network and mobile device based control commands, and others.

In one embodiment, the SIM card may send a command via SMS to the mobile device to launch a support application (block 810). In another embodiment, the SIM card may send a command via USSD (unstructured supplementary service data) to the mobile device to launch a support application (block 812). In yet another embodiment, the SIM card may send a command to the mobile device to launch a browser to a URL (block 814). In an alternative embodiment, the SIM card may display a support function on a SIM based browser or application (block 816). In addition, mobile devices with advanced SIM capabilities may send a command to the mobile device to launch a resident support application (block 818), or send a command to the mobile device to launch a support application on the device itself (block 820).

Thus, the system enables the SIM to communicate with the mobile device using different services and channels, enabling the SIM to cause the mobile device to perform a number of different functions based on scripts executing on the SIM.

### SIM Based Operating System

In addition to the services provided by the SIM as described herein, in some cases the SIM enables the system to extend the operating system of the mobile device to include a SIM-based operating system. The system may extend the operating system of a mobile device via an OS extension allotted to the memory of a SIM card (or other similar device, such as a USIM, UICC, and other smart cards with processing capabilities) residing in the mobile device. In some cases, the system enables service providers and device manufacturers to design and build a base OS for their devices. They may then utilize operating system extensions contained on a SIM card to modify and/or enhance their devices before the devices are operated by a user. For example, a manufacturer may build and send base mobile devices (each containing a base OS) to market. The manufacturer continues to develop functionalities and enhancements, and may then implement such modifications via SIM cards that update the base devices previously purchased by users. Therefore, manufacturers may send mobile devices having a base functionality to users and later enhance their functionality via subsequently developed SIM devices.

The OS extension, an extended embedded operating system (EEOS), may be a proprietary operating system optionally extended by the advanced functionality SIM devices described herein. Some of these SIM devices contain SIM components and memory components. The SIM devices may have up to 1 GB or more of memory. In some cases, the EEOS may reside on memory cards having similar security functionality as in SIM devices.

Similarly, the system enables a device manufacturer to develop a base mobile device to be used with different service providers. For example, the device manufacturer may design a device containing functionality generic to all service providers, and modify the devices to meet the needs of service providers via SIM based operating system extensions.

In some cases, embedding an operating system on a SIM card enables the system to reduce the physical memory of a mobile device. Therefore, the system may store applications, files, and OS extensions on the SIM card, freeing up a mobile device's physical memory for other applications or uses.

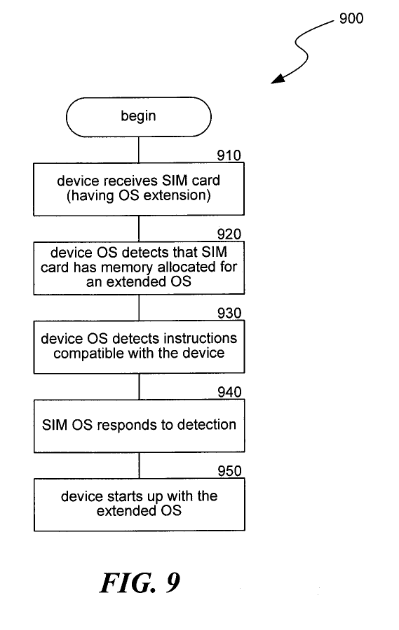

Referring to FIG. 9, a flow diagram illustrating a routine 900 for installing a SIM-based operating system extension on a mobile device is shown. In step 910, a mobile device receives a SIM card, such as a SIM or other UICC card containing an extended operating system or provisioned to receive an EEOS from a network. In step 920, a base OS operating on the mobile device detects that the inserted SIM card contains memory capable of being allocated for an extended OS. In step 930, the mobile device OS determines the existence or compatibility of the OS extension. The mobile device OS may retrieve instructions (such as executable code) within the SIM memory that are designed for the mobile device and compatible with the mobile device OS. In some cases, there may be instructions executing on the SIM processor that query the mobile device OS to determine the compatibility of the OS extension, as is described above.

Results of the queries may indicate that the SIM/UICC does not contain any OS extensions compatible with the device OS, or that the version of the OS extension is not compatible (such as not being a current version) with the base OS. In some cases, the device (or the SIM) may request executable code or other resources from a network location via a uniform resource locator (URL), depending on results of the queries. In some cases, The URL may be stored in the EEOS or in other memory.

For example, the device OS detects an OS extension version 1.0. The device OS contains instructions that require a later version, 1.1. In this example, the device OS may attempt to retrieve the version 1.1 from a network location based on a stored or received URL (or, alternatively, from other memory locations, such as in the extended OS, from a memory card, and so on).

In step 940, upon the device OS detecting a compatible OS extension (or, the availability of one), the extended OS responds to the device OS. For example, the extended OS may begin to reconfigure the device, to update resources on the device, and so on. In step 950, the system reboots the device using the extended OS. In some cases, the system may power down and restart the device during the rebooting process (such as when the device loads instructions or resources). When the SIM card is removed, the device may optionally uninstall the OS extension, in effect reverting the operating system to the base OS.

In some cases, some or all of the steps of FIG. 9 may be performed in combination with some or all steps shown in FIG. 6. For example, steps 620 and 920 may be performed together as one step. Therefore, the system enables both the executing of SIM-based resources and SIM-based OS extension instructions during an initial or subsequent installation of a SIM card into the device.

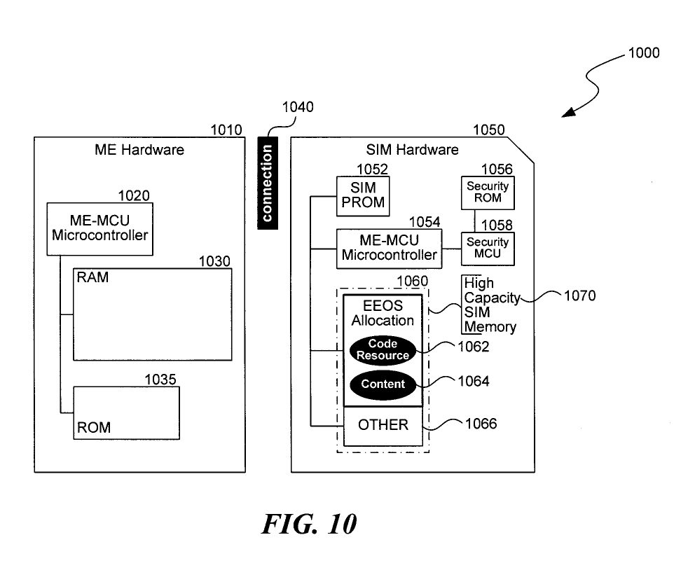

Referring to FIG. 10, a block diagram 1000 illustrating a device containing a base OS and an extended OS is shown. The device may contain mobile equipment hardware 1010 and SIM hardware 1050. Mobile equipment hardware may be any hardware used in operation of the mobile device. For example, the hardware may contain a device microcontroller 1020, device RAM 1030, device ROM 1035, and other components (e.g., those described with respect to FIG. 1) The SIM hardware, connected via a high-speed connection 1040 (such as USB, RFID, and other contact and contact-less interfaces) to the mobile device hardware 1010, may contain a SIM microcontroller 1054 that communicates with a SIM PROM 1052, SIM security ROM 1056, a SIM security microcontroller unit (MCU) 1058, and a High Capacity SIM memory 1060 which forms part of the high capacity memory 1070 of the SIM 1050. The High Capacity SIM memory 1060 contains an OS extension allotment (consisting of code resources 1062 and content resources 1064), and in some cases other high capacity memory 1066, accessed by the SIM microcontroller 1054 and/or SIM PROM 1052. The SIM hardware 1050 may also contain other memory not allotted to the EEOS. Therefore, the system provides extended operating system functionality to the mobile device via the SIM hardware 1050.

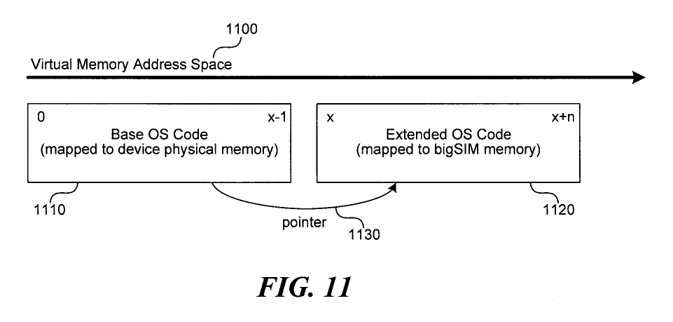

In some examples, virtual memory address space is used to implement the extended embedded operating system. FIG. 11 is a block diagram 1100 illustrating an example of virtual memory address space. Code or instructions 1110 of the base OS operating on the device, mapped to physical memory of the device, may contain a pointer 1130 to extended OS code or instructions 1120, mapped to the SIM memory. The pointer may be one or more INTERRUPT pointers for extended OS system calls, or may be a NULL pointer when the SIM does not contain an extended OS in memory. In some cases, such as when the system uninstalls the extended OS, the system may disable INTERRUPT pointers to the extended OS. The system may populate the pointer upon or during the installation of the OS extension code to the device.

Virtual memory management software or hardware, such as a memory management unit (MMU) stored on the device or on the SIM, may map addressable memory to the extended OS 1062 and 1064. The memory may optionally be cached on the device 1010, such as in the device RAM 1030 or in device MCU 1020 internal cache or memory. Caching some memory may assist in avoiding throughput or latency over connection 1040. Alternatively, to a virtual memory addressing scheme, the system may install all, or buffer some portions of, the extended OS content 1062, 1064 into some of the memory space that is otherwise reserved for base OS code 1110.

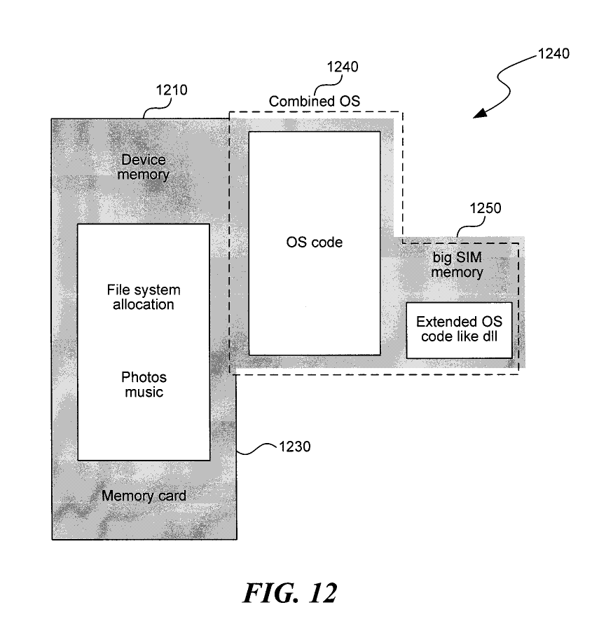

Thus using an embedded operating system stored within a SIM, the system may establish an extended operating system that resides in part on both the mobile device and the SIM. FIG. 12 is a block diagram illustrating an extended memory and/or storage architecture for a mobile device containing a SIM. The system provides a combined operating system 1240 over device memory components (such as physical memory 1210 and removable memory 1230) and SIM memory 1250. The device memory 1210 may contain allocations for the file system, or may allocate some of the file system to removable memory 1230, such as storage for content (photos, music, user data, and so on). The SIM memory provides the OS extension to the device, which may update, configure and/or modify the file system stored on the device.

Aspects of the extended embedded operating system dynamically move data between the base OS and the EEOS (or between the allotted memories of each OS). In some cases, the system is able to free up memory for faster processes by moving slower or stagnant data to the other memory.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device (either before being given to a subscriber, or during a subscriber call), the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. For example, while only one aspect of the system is recited as embodied in a computer-readable medium, other aspects may likewise be embodied in a computer-readable medium. Accordingly, the inventors reserve the right to add additional claims after filing the application to pursue such additional claim forms for other aspects of the system.

We claim:

1. A removable memory device for use with a mobile phone, the removable memory device comprising:
a memory component, the memory component containing one or more configurable scripts that execute upon connection of the memory device to the mobile phone;
a processing component, the processing component configured to execute the one or more configurable scripts; and
a presentation component, wherein the presentation component presents information to the mobile phone based on the executed one or more scripts, and wherein the presentation component presents information to the mobile phone via the removable memory device.

2. The removable memory device of claim 1, wherein the processing component detects a configuration of the mobile phone, and selects one of the one or more configurable scripts for execution based on the detected configuration.

3. The removable memory device of claim 1, wherein the processing component detects that a number for a phone call placed by the mobile phone matches a number stored within memory of the removable memory device, and selects one of the one or more configurable scripts for execution based on the match.

4. The removable memory device of claim 1, wherein the removable memory device includes a subscriber identity module (SIM).

5. A method of presenting information to a user of a mobile device via a user interface on the mobile device, the method comprising:
receiving an input from the user at the mobile device, wherein the input relates to a user-desired action to be performed by the mobile device;
presenting an indication of the input to an action component stored within a subscriber identity module contained in the mobile device;
receiving at a user interface component and from the action component a command to present information to the user; and
presenting the information to the user by instructing a user interface of the mobile device to perform a function related to the presented information.

6. The method of claim 5, wherein receiving an input from the user includes receiving input related to a call to be placed to a phone number, the method further comprising:
determining that the phone number for the phone call matches a particular phone number within a database of phone numbers stored within the subscriber identity module contained in the mobile device; and
intercepting the phone call and re-routing the phone call to the mobile device;
wherein the presented information relates to a party associated with the phone number.

7. The method of claim 5, further comprising:
requesting, via the user interface component and from the action component, the command to present information to the user.

8. A method of providing resources to a mobile phone via a subscriber identity module (SIM) card or other removable processor with memory, the method comprising:
detecting attributes of the mobile phone using a component stored in memory of the subscriber identity module or other removable processor;
executing a configuration script related to the detected attributes, wherein at least part of the configuration script is stored in memory of the subscriber identity module or other removable processor; and
providing resources to the mobile device using the executed script, wherein the resources are primarily unassociated with personalizing the mobile phone for a user.

9. The method of claim 8, wherein the executed configuration script retrieves the resources from a server connected to the mobile phone over a network.

10. The method of claim 8, wherein detecting attributes of the mobile phone includes detecting attributes during installation of the subscriber identity module or other removable processor with memory into the mobile device.

11. The method of claim 8, wherein the resources include resources that provide a branded environment for a service provider related to the subscriber identity module or other removable processor with memory.

12. The method of claim 8, wherein the configuration script is executed within the subscriber identity module or other removable processor with memory, and the resources are installed via commands received by the mobile phone from the subscriber identity module or other removable processor with memory.

13. A computer-readable medium stored within a subscriber identity module carried by a mobile device whose contents cause the mobile device to perform a method of providing enhanced services to a user of the mobile device, the method comprising:
upon receiving an indication of a call placed by the user of the mobile device, instructing, via the subscriber identity module, the mobile device to intercept the placed call;
selecting, via the subscriber identity module, a script from one or more scripts stored within a memory of the subscriber identity module; wherein the script is related to the intercepted call; and
presenting information to the user via a user interface of the mobile device, wherein the presented information relates to an execution of the selected script within the subscriber identity module that causes the user interface to present the information.

14. The computer-readable medium of claim 13, wherein an event manager stored within the mobile device selects the script related to the intercepted call.

15. The computer-readable medium of claim 13, wherein selecting a script includes transmitting information from the mobile device to the computer-readable medium via an abstraction layer.

16. The computer-readable medium of claim 13, wherein presenting information to the user via the user interface includes:
receiving instructions from the computer-readable medium via an abstraction layer, wherein the instructions relate to the executed script; and
presenting information based at least in part on the received instructions.

17. A system, comprising:
a portable wireless telecommunication apparatus for exchanging communications with a wireless network, wherein the apparatus includes:
a output device for presenting information to a user;
an input device for receiving input from the user;
a radio for exchanging the communications with wireless network, memory; and
a processor coupled among the display screen, input device, radio, and memory; and
a removable memory device configured to be carried by and to communicate with the portable wireless telecommunication apparatus, wherein the removable memory device includes:
memory, wherein the memory stores one or more applications that cause the portable wireless telecommunication apparatus to perform an action; and
a processor coupled to the memory of the removable memory device, that executes the one or more applications stored within the memory of the removable memory device, wherein an input received by the user via the input device causes the execution of the one or more applications to present the information via the output device.

18. The system of claim 17, wherein the portable wireless telecommunications apparatus includes:
an abstraction layer, wherein the abstraction layer facilitates data communications between the portable wireless telecommunications apparatus and the removable memory device.

19. The system of claim 17, wherein the portable wireless telecommunications apparatus includes an event manager that receives input from the user and communicates an indication of the input to the removable memory device.

20. The system of claim 17, wherein the portable wireless telecommunications apparatus includes a user interface manager that receives instructions from the executed one or more applications and presents information to the user via the display screen.

21. A mobile device having an extended operating system, the extended operating system comprising:
a mobile equipment operating system, including:
memory; and
a processing component; and
a removable memory device operating system, including:
a memory; and
a processing component.

22. The removable memory device of claim 21, wherein the removable memory device operating system is contained within a subscriber identity module.
